(19) United States
(12) Patent Application Publication
(10) Pub. No.: US 2002/0081495 A1
(43) Pub. Date: Jun. 27, 2002

(54) Nonaqueous electrolyte secondary battery

(76) Inventors: Hiroshi Nakajima, Osaka (JP); Seiji Yoshimura, Osaka (JP); Maruo Kamino, Osaka (JP)

Correspondence Address: KUBOVCIK & KUBOVCIK, SUITE 710, 900 17TH STREET NW, WASHINGTON, DC, 20006

(21) Appl. No.: 09/985,663

(22) Filed: Nov. 5, 2001

(30) Foreign Application Priority Data
Nov. 8, 2000 (JP) 2000-340229
Feb. 22, 2001 (JP) 2001-46514

(51) Int. Cl. H01M 4/52; H01M 4/62

(52) U.S. Cl. 429/231.3; 429/231.5; 429/232

(57) ABSTRACT

A nonaqueous electrolyte secondary battery comprising: a positive electrode composed of a metal oxide; a negative electrode composed of carbon material capable of electrochemically absorbing and desorbing lithium; and a nonaqueous electrolyte, wherein LiCo₁₋ₐTiₐO₂ (0.003≦a≦0.015) is used as positive active material.

### BACKGROUND OF THE INVENTION

1. Field of the Invention

The present invention relates to nonaqueous electrolyte secondary batteries.

2. Related Art

In recent years, as the development of electronic technology has surged forward, electronic and communication devices including cellular phones and camcorders are getting higher in performance and smaller in size. For this, there is a strong demand for secondary batteries smaller in size and higher in energy density, which are mounted in these devices. Known as secondary batteries with a high energy density are cylindrical or angular lithium ion batteries in which a metal oxide is used for the positive electrode and a carbon material is used for the negative electrode. In order to meet the demand for downsizing and lower profile while maintaining a high energy density, coin type lithium secondary batteries are being developed.

There are prior art coin type lithium secondary batteries in which an oxide or a sulfide of a transition metal such as manganese dioxide (MnO₂) or molybdenum disulfide (MOS₂) is used as the positive electrode active material, and a lithium metal or a lithium alloy is used as the negative electrode active material. Batteries with such active materials, however, have the problem that a repetition of charges and discharges causes the lithium metal or the lithium alloy to have a rough surface, making it impossible to have satisfactory cycle characteristics.

In the prior art cylindrical or angular lithium ion batteries with a spiral structure, charge transfer resistance or diffusion resistance in the direction of the thickness of the plates can be reduced with relatively by making the electrode plates thinner and longer. On the other hand, in the coin type secondary batteries, in which a metal oxide is used for the positive electrode and a carbon material is used for the negative electrode as in the cylindrical or angular lithium ion batteries so as to solve the above-mentioned inconveniences during the charge/discharge cycle, the electrode plates need to be thicker to some extent because their area is limited due to the structure of the batteries. As a result, it has a problem that the charge transfer resistance or the diffusion resistance increase and charge/discharge characteristics decrease.

### SUMMARY OF THE INVENTION

An object of the present invention is to provide a nonaqueous electrolyte secondary battery having small charge transfer resistance and small diffusion resistance within electrodes as well as excellent charge/discharge characteristics.

The nonaqueous electrolyte secondary battery according to a first aspect of the present invention includes: a positive electrode composed of a metal oxide; a negative electrode composed of carbon material capable of electrochemically absorbing and desorbing lithium; and a nonaqueous electrolyte, wherein an active material of the positive electrode is LiCo₁₋ₐTiₐO₂ (0.003≦a≦0.015).

The first aspect of the present invention will be described below.

According to the first aspect of the present invention, the use of LiCo₁₋ₐTiₐO₂ (0.003≦a≦0.015) as positive active material realizes an improvement in cycle characteristics and load characteristics compared with LiCoO₂ in which Ti is not substituted. When the amount of Ti to be substituted is smaller than 0.003, cycle characteristics are not improved because the crystal structure is not stable, and load characteristics are not improved because the resistance of the positive active material does not drop largely. When the amount of Ti to be substituted is larger than 0.015, the charge/discharge capacity decreases and more impurities are produced during the baking of the active material. When the amount of Ti to be substituted is 0.006 to 0.012, these effects become remarkable, thereby further improving the charge/discharge characteristics.

The positive active material having a mean particle diameter of 2 to 30 μm allows the positive active material to be fully used so as to further improve the charge/discharge characteristics. When its particle diameter is smaller than 2 μm, the positive active material becomes likely to be dissolved in the electrolyte so as to decrease the cycle characteristics. When the particle diameter is larger than 30 μm, a smaller area of the positive active material gets in contact with the electrolyte, thereby decreasing the cycle characteristics. When the particle diameter is in the range of 5 to 15 μm, these effects become remarkable, thereby further improving the charge/discharge characteristics.

When dimethyl carbonate (DMC) is contained in the nonaqueous electrolyte, dimethyl carbonate itself has a high electric conductivity and simultaneously forms a dense film on a surface of the positive active material, LiCo₁₋ₐTiₐO₂, thereby improving the charge/discharge characteristics. When the volume content of dimethyl carbonate is 10 to 90%, these effects become remarkable, thereby further improving the charge/discharge characteristics. When the volume content of dimethyl carbonate is 30 to 70%, these effects become further remarkable, thereby still further improving the charge/discharge characteristics.

When dimethyl carbonate and ethyl methyl cabonate (EMC) are contained in the nonaqueous electrolyte, these form a more dense film on a surface of the positive active material, LiCo₁₋ₐTₐO₂, thereby further improving the charge/discharge characteristics.

The positive electrode is preferably 0.1 to 1.2 mm thick. This range of thickness allows the positive active material to be fully used so as to further improve the charge/discharge characteristics. When the positive electrode is thinner than 0.1 mm, the capacity maybe too small and the electrode may become less durable. When the positive electrode is thicker than 1.2 mm, the electrode is durable; however, diffusion resistance and charge transfer resistance in the direction of the thickness may be so large that the charge/discharge characteristics decrease. When the positive electrode is in the range of 0.3 to 0.8 mm thick, these effects become remarkable, thereby further improving the charge/discharge characteristics.

The nonaqueous electrolyte secondary battery according to a second aspect of the present invention is a coin type nonaqueous electrolyte secondary battery includes: a positive electrode plate composed of a cathode mix containing positive active material composed of a metal oxide, an electronic conductor, and a binder; a negative electrode plate composed of carbon material capable of electrochemically absorbing and desorbing lithium; a separator disposed between the positive electrode plate and said negative electrode plate; and a nonaqueous electrolyte, wherein the positive electrode plate is 0.1 to 1.2 mm thick, and the cathode mix contains 8.2 to 14.0% by weight of the electronic conductor.

The second aspect of the present invention will be described below.

When the thickness of the positive electrode plate is set at 0.1 to 1.2 mm, a capacity can be secured to some extent while the positive active material can be utilized effectively. When the positive electrode plate is thinner than 0.1 mm, the capacity is too small and the electrode becomes less durable. When the positive electrode is thicker than 1.2 mm, the electrode is durable; however, diffusion resistance and charge transfer resistance in the direction of the thickness are too large.

When the content of the electronic conductor is 8.2 to 14.0% by weight, the positive active material is used effectively and a good film is formed on the electrode, thereby increasing the charge/discharge efficiency. When the content is less than 8.2% by weight, the positive active material is not used effectively. When the content is more than 14.0% by weight, too much energy is consumed when the electronic conductor reacts with the electrolyte to form a film, thereby decreasing the charge/discharge efficiency.

The positive electrode plate is more preferably 0.3 to 0.8 mm thick. This range of thickness further improves the charge/discharge characteristics. The content of the electronic conductor is more preferably 9.0 to 11.5% by weight. This range of content further improves the charge/discharge characteristics.

In the second aspect of the present invention, the positive active material preferably has a mean particle diameter of 2 to 20 μm. This range of mean particle diameter makes the positive active material, electronic conductor, and binder be mixed evenly, thereby improving the charge/discharge characteristics. When the positive active material has a mean particle diameter smaller than 2 μm, the electronic conductor fails to cover the positive active material sufficiently, and the positive active material becomes likely to be dissolved in the electrolyte. When the positive active material has a mean particle diameter larger than 20 μm, the positive active material and electronic conductor cannot be mixed evenly, and a smaller area of the positive active material gets in contact with the electrolyte.

In the second aspect of the present invention, the cathode mix preferably has a packing density of 2.6 to 3.1 g·cm⁻³. This range of packing density allows the positive active material to be used fully, thereby further improving the charge/discharge characteristics. When the packing density is less than 2.6 g·cm⁻³, the positive active material, electronic conductor, and binder are not mixed evenly, and capacity per volume of the positive electrode decreases. When the packing density is more than 3.1 g·cm⁻³, too much a pressure is applied that the electronic conductor fails to cover the positive active material sufficiently and evenly.

### BRIEF DESCRIPTION OF THE DRAWINGS

FIG. 1 is a cross sectional view showing the coin type lithium secondary battery fabricated in the first example of the present invention.

FIG. 2 is a diagram showing the relation between the amount of Ti doped in lithium cobaltate, which is the positive active material, and discharge capacity and load characteristics in a lithium secondary battery using thereof.

FIG. 3 is a diagram showing the relation between the particle diameter and capacity retention of the positive active material in the first aspect of the present invention.

FIG. 4 is a diagram showing the relation between the packing density, charge/discharge efficiency and discharge capacity of the positive electrode plate in the second aspect of the present invention.

### DESCRIPTION OF PREFERRED EXAMPLES

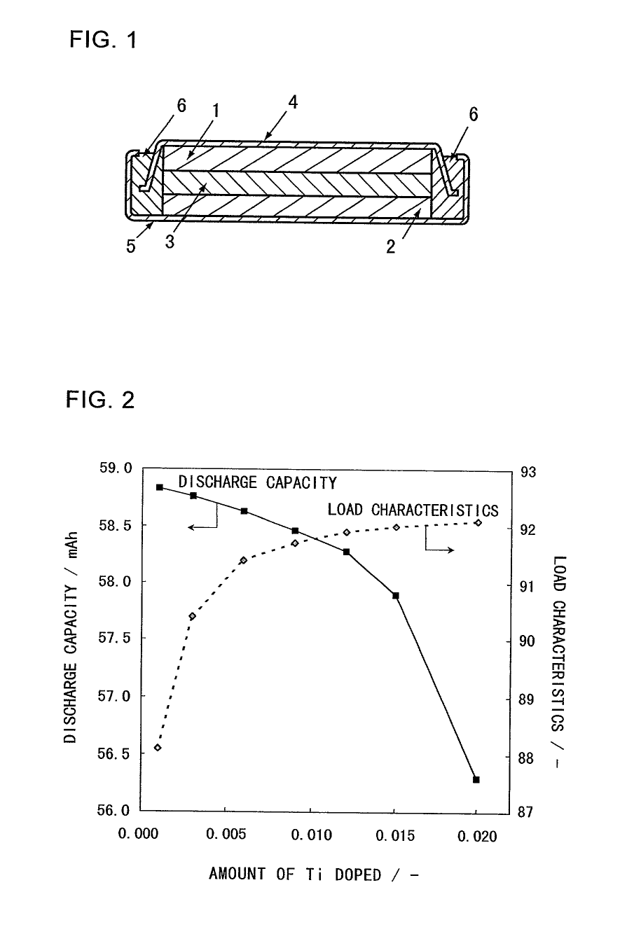

In a nonaqueous electrolyte secondary battery of one example in accordance with the present invention, as shown in FIG. 1, a separator 3 is interposed between a positive electrode 1 and a negative electrode 2, and all of which are stored in a positive electrode case 4 and a negative electrode case 5 sealed with an insulator packing 6.

In the first aspect, the positive electrode 1 is composed of a mixture of LiCo₁₋ₐTiₐO₂ (0.003≦a≦0.015) as the positive active material, an electronic conductor, and a binder. In the second aspect, the positive electrode 1 is composed of a mixture of a positive active material, an electronic conductor, and a binder. The positive active material used in the second aspect can be LiCoO₂, LiNiO₂, LiMn₂O₄, LiMnO₂, Li-containing MnO₂, LiCo_{0.5}Ni_{0.5}O₂, LiCo_{0.2}Ni_{0.8}O₂, or LiCo_{0.7}Ni_{0.2}Mn_{0.1}O₂.

The negative electrode 2 is composed of a mixture of a negative active material made of a carbon material capable of electrochemically absorbing and desorbing lithium, an electronic conductor, and a binder. It is preferable that a sponge-like conductive holder or the like is used for the negative electrode due to increasing strength and conductivity thereof. This sponge-like conductive holder may be also used for the positive electrode.

As the negative active material, carbon material capable of electrochemically absorbing and desorbing Li, such as graphite (natural graphite and artificial graphite), cokes, and calcined organics are illustrated.

As the conductive material used for the positive and the negative electrode, carbon material including natural graphite (scare-like graphite, mud-like graphite, and others), artificial graphite, carbon black, acetylene black, ketjen black, and carbon fiber are illustrated.

As the binder used for the positive and the negative electrode, polytetrafluoroethylene, poly(vinylidene fluoride), polyvinyl pyrrolidone, polyvinyl chloride, polyethylene, polypropylene, ethylene—propylene—dientapolymer, styrene butadiene rubber, carboxymethyl cellulose, fluorine rubber, or polyamidic acid are illustrated.

It is preferable to use graphite and acetylene black together as the electronic conductor used for the positive electrode, and it is more preferable for graphite and acetylene black to be in the weight ratio of 3/7 to 7/3. The amount of the positive active material to be added is preferably so that the capacity of the positive electrode is 0.80 to 1.20 times as much as that of the negative electrode, more preferably 0.90 to 1.20 times, more preferably 0.90 to 1.10 times, and further more preferably 0.95 to 1.10 times.

The binder used for the positive electrode is preferably poly(vinylidene fluoride), whose preferable amount to be added is 1 to 10% by weight, and more preferable amount is 3 to 6% by weight. The sponge-like holder used for the positive electrode is preferably made of a porous conductive material having a porosity of about 80 to 99% and a thickness of 0.3 to 2.0 mm, and its main material is preferably aluminum or stainless steel. The sponge-like holder used for the negative electrode is preferably made of a porous conductive material having a porosity of about 80 to 99% and a thickness of 0.3 to 2.0 mm, and its main material is preferably nickel sponge.

As the separator 3, material capable of absorbing an electrolyte, such as polypropylene unwoven cloth, micro porous polypropylene film, or microporous polypropylene unwoven cloth are illustrated.

The solvent for the nonaqueous electrolyte with which the separator 3 is impregnated preferably contains dimethyl carbonate, and more preferably contains dimethyl carbonate and ethylene carbonate (EC). It is further preferable to use a mixture solvent of ethylene carbonate, dimethyl carbonate, and ethyl methyl carbonate. Further, it may be used a mixture solvent of cyclic carboxylic acid ester such as propylene carbonate (PC) or γ-butyrolactone (γ-GBL) and chain carboxylic ester such as dimethyl carbonate (DMC), diethyl carbonate (DEC), ethyl methyl carbonate (EMC) or methyl acetate (MA); or a solvent consisting of the mixture solvent and either one of cyclic ether such as tetrahydrofuran (THF) or chain ether such as 1,2-dimethoxy ethane (DME).

As the solute for the nonaqueous electrolyte, salt of inorganic acid such as hexafluoride lithium phosphate (LiPF₆), LiBF₄, LiSbF₆, LiAsF₆, or LiClO₄, or salt of organic acid such as LiN(CF₃SO₂)₂, LiN(C₂F₅SO₂)₂, or LiC(CF₃SO₂)₃ are illustrated. It is particularly preferable that solute of the nonaqueous electrolyte is hexafluoride lithium phosphate, and its preferable amount is 0.6 to 1.6 mol/liter, more preferable amount is 0.8 to 1.6 mol/liter, and further more preferable amount is 0.8 to 1.2 mol/liter.

The positive electrode case 4 and the negative electrode case 5 are formed into a cylindrical shape with a bottom by pressing stainless steel or the like. It is preferable to apply a conductive coating composed of a mixture of graphite powder and water glass on the inner surface of the bottom of the positive electrode case 4, or to provide a mesh-like positive electrode current collector composed of stainless steel, aluminum, titanium, or the like in order to improve conductivity between the positive electrode 1 and the positive electrode case 4. It is preferable to apply a conductive coating composed of a mixture of graphite powder and water glass on the inner surface of the bottom of the negative electrode case 5, or to provide a mesh-like negative electrode current collector composed of stainless steel, copper, titanium, or the like in order to improve conductivity between the negative electrode 2 and the negative electrode case 5.

### EXAMPLES

Examples according to the first aspect of the present invention will be described below.

Batteries of the present invention and batteries of Comparative Examples were fabricated as follows, and their charge/discharge characteristics were measured.

[Experiment 1]

### Example 1

Lithium carbonate (Li₂CO₃), cobalt carbonate (CoCO₃) , and titanium chloride (TiCl₂) were mixed in the mole ratio of 0.5:0.997:0.003, and the obtained mixture was baked in the air at 900° C. to produce LiCo_{0.997}Ti_{0.003}O₂, and pulverized by a jet mill until the mean particle diameter became 10 μm. This was used as the positive active material, a mixture of graphite and acetylene black in the weight ratio of 1:1 was used as the electronic conductor, and poly(vinylidene fluoride) was used as the binder, and the positive active material, the electronic conductor, and the binder were kneaded in the weight ratio of 87:8:5 so as to prepare a cathode mix. The cathode mix was if pressed to prepare a positive electrode 20 mm in diameter, 0.6 mm in thickness, and 2.8 g·cm⁻³ in packing density.

The negative electrode was prepared as follows: artificial graphite was kneaded with 2% by weight of water dispersion of carboxymethyl cellulose as a thickener and with 1% by weight of an aqueous solution of styrene butadiene latex as the binder to form an anode mix slurry, and then the anode mix slurry was filled into nickel sponge, dried, rolled, and stamped to have a diameter of 20 mm and a thickness of 0.9 mm. The packing rate and density of the anode mix can be controlled by changing the thickness of the nickel sponge before the anode mix is packed, the packing amount of the anode mix, and rolling conditions. In the present experiment, 3.0 mm-thick nickel sponge is used to set the density of the mix at 1.2 g·cm⁻³.

The separator made by stamping out a polypropylene microporous film so as to have a diameter of 21 mm was used.

The negative electrode, separator, and positive electrode were stacked as shown in FIG. 1 inside the negative electrode case. After an insulator packing is attached, a nonaqueous electrolyte, in which ethylene carbonate, dimethyl carbonate, and ethyl methyl carbonate were mixed in the volume ratio of 30:50:20, and 1.1 mol/liter of hexafluoride lithium phosphate was dissolved, was injected in the negative electrode case, and the positive electrode case was covered to be caulked, thereby preparing battery A1 of the present invention.

### Examples 2-5

Batteries A2, A3, A4, and A5 of the present invention are fabricated under the same conditions as battery A1 of the present invention except that the mole ratio of lithium carbonate, cobalt carbonate and titanium chloride was changed to 0.5:0.994:0.006, 0.5:0.991:0.009, 0.5:0.988:0.012, and 0.5:0.985:0.015, respectively, so as to produce positive active materials, LiCo_{0.994}Ti_{0.006}O₂, LiCo_{0.991}Ti_{0.0090}O₂, LiCo_{0.988}Ti_{0.012}O₂, and LiCo_{0.985}Ti_{0.015}O₂, respectively.

### Comparative Examples 1 and 2

Batteries X1 and X2 of Comparative Examples 1-2 were fabricated under the same conditions as battery A1 of the present invention except that the mole ratio of lithium carbonate, cobalt carbonate, and titanium chloride was changed to 0.5:0.999:0.001, 0.5:0.980:0.020, respectively, so as to produce positive active materials, LiCo_{0.999}Ti_{0.001}O₂, and LiCo_{0.98}Ti_{0.020}O₂, respectively.

≦Evaluation Test>

The charge/discharge characteristics the battery were evaluated with respect to batteries A1-A5 of the present invention and batteries X1-X2 of Comparative Examples 1-2 fabricated in the above-described method.

The measurement of the charge/discharge characteristics was conducted at a condition of a constant current of 3 mA and 10 mA at 25° C., an upper-limit voltage of 4.2 V, and a lower-limit voltage of 3.0 V so as to examine discharge capacity at 3 mA and load characteristics (=(discharge capacity at 10 in A) (discharge capacity at 3 mA)) of each battery.

The results are shown in FIG. 2.

It has turned out from FIG. 2 that load characteristics are high when the amount of Ti doped is 0.003 or more, and are higher when the amount is 0.006 or more, and that discharge capacity is large when the dope amount of Ti is 0.015 or less, and is larger when the amount is 0.012 or less.

[Experiment 2]

### Examples 6-9

Batteries B1, B2, B3, and B4 of the present invention were fabricated under the same conditions as battery A3 of the present invention except that LiCo_{0.099}Ti_{0.009}O₂ was produced, and that its metal oxide was pulverized by a jet mill until the mean particle diameter became 2 μm, 5 μm, 15 μm, and 30 μm, respectively.

### Examples 10 and 11

Batteries Y1 and Y2 of the present invention were fabricated under the same conditions as battery A3 of the present invention except that LiCo_{0.991}Ti_{0.009}O₂ was produced, and that its metal oxide was pulverized by a jet mill until the mean particle diameter became 1 μm and 40 μm, respectively.

≦Evaluation Test>

A charge/discharge test was conducted with respect to batteries A3, B1-B4, and Y1-Y2 of the present invention fabricated in the above-described method, at a condition of a constant current of 10 mA at 25° C., an upper-limit voltage of 4.2 V, and a lower-limit voltage of 3.0 V so as to examine capacity retention of each battery after 20 cycles (=(discharge capacity at 20th cycle)÷(discharge capacity at 1st cycle)×100 ).

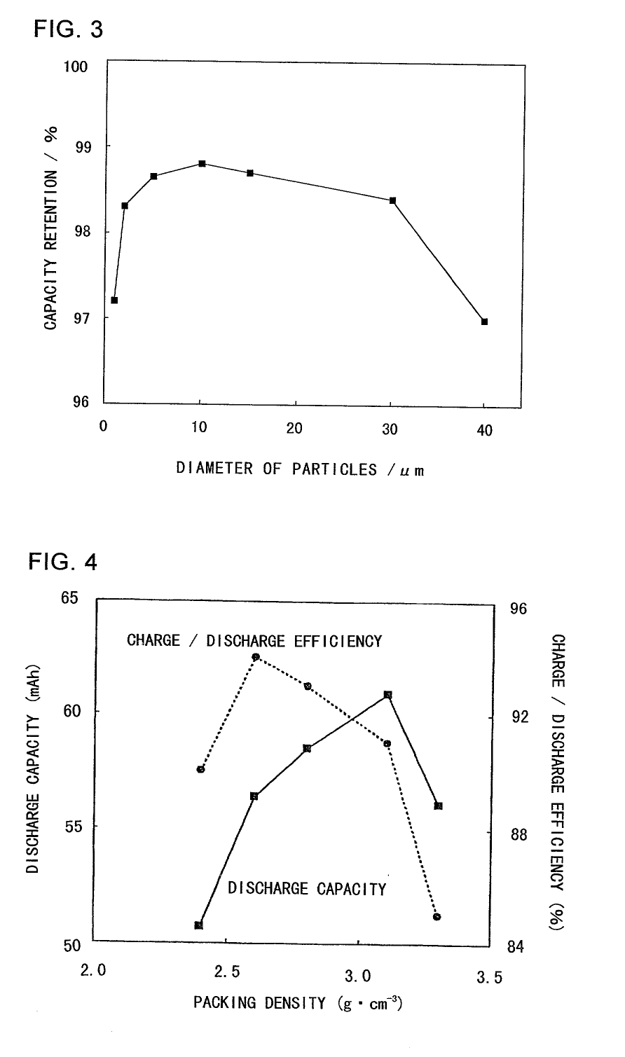

The results are shown in FIG. 3.

It has turned out from FIG. 3 that charge/discharge cycle characteristics are high when particles of the positive active material are 1 to 30 μm in diameter, and are higher when the particles are 2 to 15 μm in diameter.

[Experiment 3]

### Examples 12-15

Batteries C1-C4 of the present invention were fabricated under the same conditions as battery A3 of the present invention except that nonaqueous electrolytes were prepared by mixing ethylene carbonate (EC), dimethyl carbonate (DMC), and diethyl carbonate (DEC) in the volume ratio of 30:5:95, 30:10:60, 30:30:40, and 30:50:20, respectively, and by dissolving 1.1 mol/liter of hexafluoride lithium phosphate in these mixture solvents.

### Examples 16-18

Batteries C5-C7 of the present invention were fabricated -sunder the same conditions as battery A3 of the present invention except that nonaqueous electrolytes were prepared by mixing ethylene carbonate (EC) and dimethyl carbonate (DMC) in the volume ratio of 30:70, 10:90, and 5:95, respectively, and dissolving 1.1 mol/liter of hexafluoride lithium phosphate in these mixture solvents.

### Example 19

Battery Z1 of the present invention was fabricated under the same conditions as battery A3 of the present invention except that a nonaqueous electrolyte was prepared by mixing ethylene carbonate (EC) and ethyl methyl carbonate (EMC) in the volume ratio of 30:70 and by dissolving 1.1 mol/liter of hexafluoride lithium phosphate in this mixture solvent.

### Example 20

Battery Z2 of the present invention was fabricated under the same conditions as battery A3 of the present invention except that a nonaqueous electrolyte was prepared by mixing ethylene carbonate (EC), ethyl methyl carbonate (EMC) , diethyl carbonate (DEC) in the volume ratio of 30:35:35 and by dissolving 1.1 mol/liter of hexafluoride lithium phosphate in this mixture solvent.

≦Evaluation Test>

With respect to batteries A3, C1-C7, and Z1-Z2 of the present invention fabricated in the above-described method, capacity retention of each battery after 20 cycles was examined under the same conditions as in Experiment 2.

The results are shown in Table 1.

TABLE 1

| | | Capacity Retention |
|---|---|---|
| Battery | Electrolyte | (%) |
| A3 | EC/DMC/EMC = 30/50/35 | 98.8 |
| C1 | EC/DMC/DEC = 30/5/65 | 97.5 |
| C2 | EC/DMC/DEC = 30/10/60 | 97.8 |
| C3 | EC/DMC/DEC = 30/30/40 | 98.2 |
| C4 | EC/DMC/DEC = 30/50/30 | 98.3 |
| C5 | EC/DMC = 30/70 | 98.3 |
| C6 | EC/DMC = 10/90 | 97.8 |
| C7 | EC/DMC = 5/95 | 97.4 |
| Z1 | EC/EMC = 30/70 | 96.0 |
| Z2 | EC/EMC/DEC = 30/35/35 | 96.2 |

It has turned out from Table 1 that charge/discharge cycle characteristics are high when the electrolyte contains dimethyl carbonate (DMC), are particularly high when the volume content of the dimethyl carbonate (DMC) is 10 to 90%, and higher when the volume content is 30 to 70%. It also turned out that charge/discharge cycle characteristics are extremely high when the electrolyte contains ethyl methyl carbonate (EMC) as well as dimethyl carbonate (DMC).

[Experiment 4]

### Examples 21-24

Batteries D1-D4 of the present invention were fabricated under the same conditions as battery A3 of the present invention except that the cathode mix was pressed to be 0.1 mm, 0.3 mm, 0.8 mm, and 1.2 mm thick, respectively.

### Examples 25 and 26

Batteries U1 and U2 of the present invention were fabricated under the same conditions as battery A3 of the present invention except that the cathode mix was pressed to be 0.05 mm and 1.4 mm thick, respectively.

≦Evaluation Test>

A charge/discharge test was conducted with respect to batteries A3, D1-D4, and U1-U2 of the present invention fabricated in the above-described method at a condition of a constant current of 3 mA at 25° C., an upper-limit voltage of 4.2 V, and a lower-limit voltage of 3.0 V so as to examine discharge capacity and charge/discharge efficiency of each battery.

The results are shown in Table 2.

TABLE 2

| | | Discharge | Charge/Discharge |
|---|---|---|---|
| | Thickness | Capacity | Efficiency |
| Battery | (mm) | (mAh) | (%) |
| D1 | 0.1 | 9.9 | 92 |
| D2 | 0.3 | 29.5 | 92 |
| A3 | 0.6 | 58.6 | 92 |
| D3 | 0.8 | 77.9 | 91 |
| D4 | 1.2 | 113.0 | 88 |
| U1 | 0.05 | 5.0 | 92 |
| U2 | 1.4 | 119.5 | 78 |

It has turned out from Table 2 that charge/discharge efficiency is high when the thickness is 1.2 mm or less, and is higher when the thickness is 0.8 mm or less. When the thickness is 0.1 mm or more, the electrode has high duration and large capacity, so that it can be used in various items such as watches, electric calculators, and back-up memories. When the thickness is 0.3 mm or more, the electrode has higher duration and larger capacity so as to expand its usage.

The positive and negative electrodes have a diameter of 20 mm in Experiments 1-4; however, in consideration of the fact that the same effects were obtained when the positive and negative electrodes were 5 mm, 10 mm, or 30mm in diameter, it is possible to fabricate nonaqueous electrolyte secondary batteries with high charge/discharge characteristics even if size of batteries are changed.

Examples according to a second aspect of the present invention will be described below.

[Experiment 5]

Experiment 5 was conducted to examine how the amount of the electronic conductor in the positive electrode plate affects battery characteristics in a coin type secondary battery.

### Examples 27-31

First, a method of fabricating the positive electrode plate will be described below.

A mixture of lithium carbonate (Li₂CO₃) and tricobalt tetraoxide (Co₃O₄) was baked at 900° C. in the air to produce lithium cobaltate (LiCoO₂), which is a metal oxide. The baked product was pulverized by a jet mill until the mean particle diameter became 10 μm so as to prepare a positive active material. On the other hand, a mixture of graphite and acetylene black in the weight ratio of 1:1 was used as the electronic conductor, and poly(vinylidene fluoride) was used as the binder. The positive active material, the electronic conductor, and the binder were kneaded in the weight ratio of 86.8:8.2:5.0 to prepare a cathode mix, which was then pressed to form a positive electrode plate 1 having 20 mm in diameter, 0.6 mm in thickness, and 2.8 g·cm⁻³ in packing density. Consequently, the cathode mix contains 8.2% by weight of the electronic conductor.

Next, the negative electrode plate was prepared as follows: artificial graphite as the carbon material for the active material was kneaded with 2% by weight of water dispersion of carboxymethyl cellulose as a thickener and with 1% by weight of an aqueous solution of styrene butadiene latex as the binder to form anode mix slurrying. Then the anode mix was filled into nickel sponge, dried, rolled, and stamped out to form the negative electrode palate 2 having a diameter of 21 mm and a thickness of 0.9 mm.

The packing rate and density of the anode mix can be controlled by changing the thickness of the nickel sponge before the anode mix is packed, the packing amount of the anode mix, and rolling conditions. In the present experiment, 3.0 mm-thick nickel sponge was used to set the density of the mix at 1.0 g·cm⁻³.

The separator made by stamping out a polypropylene microporous film so as to have a diameter of 22 mm was used.

The negative electrode plate, separator, and positive electrode were stacked inside the negative electrode case separately prepared, and insulator packing was attached. Then a nonaqueous electrolyte in which ethylene carbonate (EC), dimethyl carbonate (DMC), and ethyl methyl carbonate (EMC) were mixed as solvents in the volume ratio of 1:1:1, and l.2mol/liter of hexafluoride lithium phosphate (LiPF₆) was dissolved as solute was injected. The positive electrode case was then covered to be caulkd, thereby preparing battery E1 of the present invention.

In addition, in Examples 28-31, batteries E2 (with an electronic conductor content of 9.0% by weight), E3 (with an electronic conductor content of 10.0% by weight), E4 (with an electronic conductor content of 11.5% by weight), and E5 (with an electronic conductor content of 14.0% by weight) of the present invention were fabricated under the same conditions as battery E1 of the present invention except that their positive electrode plates contain the positive active material, the electronic conductor, and the binder in the weight ratio of 86.0:9.0:5.0, 85.0:10.0:5.0, 83.5:11.5:5.0, and81.0:14.0:5.0, respectively.

### Comparative Examples 3 and 4

Batteries X3 (with an electronic conductor content of 6.0% by weight) and X4 (with an electronic conductor content of 16.0% by weight) of Comparative Examples 3-4 were fabricated under the same conditions as battery El of the present invention except that their positive electrode plates contain the positive active material, the electronic conductor, and the binder in the weight ratio of 89.0:6.0:5.0 and 79.0:16.0:5.0, respectively.

≦Evaluation Test>

With respect to Batteries E1-E5 of the present invention and batteries X3-X4 of Comparative Examples 3-4, charge/discharge characteristics were evaluated. The measurement of the charge/discharge characteristics was conducted at a condition of a constant current of 3 mA at an atmospheric temperature of 25° C., a charge end voltage of 4.2 V, and a discharge end voltage of 3.0 V, so as to examine discharge capacity and charge/discharge efficiency of each battery.

The results are shown in Table 3.

TABLE 3

| | Electronic | Discharge | Charge/Discharge |
|---|---|---|---|
| | Conductor | Capacity | Efficiency |
| Battery | (% by weight) | (mAh) | (%) |
| E1 | 8.2 | 57.8 | 90 |
| E2 | 9.0 | 58.8 | 92 |
| E3 | 10.0 | 58.8 | 92 |
| E4 | 11.5 | 58.5 | 92 |
| E5 | 14.0 | 57.4 | 91 |
| X3 | 6.0 | 54.1 | 83 |
| X4 | 16.0 | 55.3 | 86 |

It has turned out from Table 3 that discharge capacity and charge/discharge characteristics are both high when the positive electrode plate contains 8.2 to 14.0% by weight of the electronic conductor, and that battery characteristics were improved by increasing 9.0 to 11.5% by weight of the electronic conductor.

[Experiment 6]

Experiment 6 was conducted to examine how the thickness of the positive electrode plate affects battery characteristics in a coin type secondary battery.

### Examples 32-35

Battery F1 (with an electronic conductor content of 10.0% by weight) of the present invention was fabricated under the same conditions as battery E1 of the present invention except that the positive active material, the electronic conductor, and the binder were mixed in the weight ratio of 85.0:10.0:5.0, and that the thicknesses of the positive electrode plate and the negative electrode plate were set at 0.1 mm and 0.15 mm, respectively.

Furthermore, batteries F2, F3, and F4 of the present invention were fabricated under the same conditions as battery F of the present invention except that the thicknesses of the positive electrode plate and the negative electrode plate were set at 0.3 mm and 0.45 mm, 0.8 mm and 1.2 mm, and 1.2 mm and 1.8 mm, respectively.

### Comparative Examples 5 and 6

Batteries X5 and X6 of Comparative Examples 5-6 were fabricated under the same conditions as battery F1 of the present invention except that the thicknesses of the positive electrode plate and the negative electrode plate were set at 0.05 mm and 0.75 mm, and 1.4 mm and 2.1 mm, respectively.

≦Evaluation Test>

With respect to batteries F1-F4 of the present invention and batteries X5-X6 of Comparative Examples 5-6, a test was conducted under the same conditions as in Experiment 5 so as to examine discharge capacity and charge/discharge efficiency of each battery.

The results are shown in Table 4. Note that battery E3 of the present invention was fabricated in Experiment 5.

TABLE 4

| | Thickness of | Discharge | Charge/Discharge |
|---|---|---|---|
| | Positive Electrode | Capacity | Efficiency |
| Battery | Plate (mm) | (mAh) | (%) |
| F1 | 0.1 | 10.0 | 92 |
| F2 | 0.3 | 29.8 | 92 |
| E3 | 0.6 | 58.8 | 92 |
| F3 | 0.8 | 78.4 | 91 |
| F4 | 1.2 | 114.8 | 88 |
| X5 | 0.05 | 5.0 | 92 |
| X6 | 1.4 | 117.2 | 77 |

It has turned out from Table 4 that charge/discharge efficiency is high when the thickness of the positive electrode plate is 1.2 mm or less, and is higher when the thickness is 0.8 mm or less. When the thickness is 0.1 mm or more, the positive electrode plate has higher duration and the battery capacity exceeds 10 mAh, so that the battery can be used in various items such as watches, electric calculators, and back-up memories. When the thickness of the positive electrode plate is 0.3 mm or more, the plate has higher duration and the battery capacity becomes 30 mAh or more, so as to expand its usage.

Although these batteries have a diameter of 21 mm, the same results were obtained when batteries were 5 mm, 10 mm, and 30mm in diameter. Thus it is possible to fabricate batteries with high charge/discharge characteristics by setting the amount of the electronic conductor in the positive electrode plate at 8.2 to 14.0% by weight, and by setting the thickness of the positive electrode plate at 0.1 to 1.2 mm even if the size of batteries are changed.

[Experiment 7]

Experiment 7 was conducted to examine how the particle diameter of the positive active material in the positive electrode plate affects battery characteristics in a coin type secondary battery.

### Examples 36-38

A method of producing the positive electrode plate will be described below. First, lithium cobaltate, which is a metal oxide, pulverized by a jet mill until the mean particle diameter became 10 μm in diameter was prepared as positive active material. A mixture of graphite and acetylene black in the weight ratio of 1:1 was used as the electronic conductor, and n-methyl pyrrolidone (NMP) in which 10% by weight of poly(vinylidene fluoride) is dissolved was used as the binder. The positive active material, the electronic conductor, and the binder were kneaded in the weight ratio of 85.0:10.0:5.00 to obtain a slurrying mixture. Note that when the slurrying mixture was dried, the cathode mix was supposed to contain the positive active material, the electronic conductor, and the binder in the weight ratio of 85.0:10.0:5.0, and also 10.0% by weight of the electronic conductor.

The cathode mix was filled into aluminum sponge, dried, rolled, stamped out so as to have a packing density of 2.8 g·cm⁻³, and stamped to form a positive electrode plate 20 mm in diameter and 0.7 mm in thickness.

On the other hand, the negative electrode plate was prepared as follows: artificial graphite was kneaded with 2% by weight of water dispersion of carboxymethyl cellulose as a thickener and with 1% by weight of an aqueous solution of styrene butadiene latex as a binder so as to form a anode mix slurrying, and then the slurrying anode mix was filled into nickel sponge, dried, rolled, and stamped out (with a diameter of 21 mm and a thickness of 0.9 mm).

Battery G1 of the present invention was fabricated under the same conditions as battery E1 of the present invention except that the above-described positive electrode plate and negative electrode plate were used.

In addition, in Examples 37 and 38, batteries G2 and G3 of the present invention were fabricated under the same conditions as battery G1 of the present invention except that their positive electrode plates contain positive active material made by pulverizing lithium cobaltate, which is a metal oxide by a jet mill until the mean particle diameter became 2 μm and 20 μm, respectively.

### Reference Examples 1 and 2

Batteries H1 and H2 of Reference Examples 1-2 were fabricated under the same conditions as battery G1 of the present invention except that positive active material made by pulverizing lithium cobaltate by a jet mill until the mean particle diameter became 1 μm and 25 μm, respectively.

≦Evaluation Test>

With respect to batteries G1-G3 of the present invention and batteries H1-H2 of Reference Examples 1-2, a test was conducted under the same conditions as in Experiment 5 so as to examine discharge capacity and charge/discharge efficiency of each battery.

The results are shown in Table 5.

TABLE 5

| | Average Size of | Discharge | Charge/Discharge |
|---|---|---|---|
| | Particles in Diameter | Capacity | Efficiency |
| Battery | (μm) | (mAh) | (%) |
| G1 | 10 | 58.5 | 93 |
| G2 | 2 | 58.2 | 92 |
| G3 | 20 | 58.1 | 92 |
| H1 | 1 | 57.3 | 90 |
| H2 | 25 | 57.0 | 89 |

It has turned out from Table 5 that discharge capacity and charge/discharge efficiency are high when the positive active material in the positive electrode plate has a mean particle diameter of 2 to 20 μm.

[Experiment 8]

Experiment 8 was conducted to examine how the packing density of the positive active material in the positive electrode plate affects battery characteristics in a coin type secondary battery.

### Examples 39-40

Battery G4 of the present invention was fabricated under the same conditions as battery G1 of the present invention except that the slurrying cathode mix was filled into aluminum sponge, dried, and rolled such that the packing density of the cathode mix became 2.6 g·cm⁻³.

Battery G5 of the present invention was fabricated under the same conditions as battery G1 of the present invention except that the rolling was conducted such that the packing density of the anode mix became 3.1g·cm⁻³.

### Reference Examples 3 and 4

Battery H3 of Reference Example 3 was fabricated under the same conditions as battery G1 of the present invention except that the slurrying cathode mix was filled into aluminum sponge, dried, and rolled such that the packing density of the cathode mix became 2.4 g ·cm-⁻³.

Battery H4 of Reference Example 4 was fabricated under the same conditions as battery G1 of the present invention except that the rolling was conducted such that the packing density of the anode mix became 3.3 g·cm⁻³.

≦Evaluation Test>

With respect to batteries G4-G5 of the present invention and batteries H3-H4 of Reference Examples 3-4, a test was conducted under the same conditions as in Experiment 5 so as to examine discharge capacity and charge/discharge efficiency of each battery.

The results are shown in FIG. 4 and Table 6. Note that battery G1 of the present invention was fabricated in Experiment 7.

TABLE 6

| | | Discharge | Charge/Discharge |
|---|---|---|---|
| | Packing Density | Capacity | Efficiency |
| Battery | (g · cm⁻³) | (mAh) | (%) |
| G1 | 2.8 | 58.5 | 93 |
| G4 | 2.6 | 56.4 | 94 |
| G5 | 3.1 | 60.9 | 91 |
| H3 | 2.4 | 50.7 | 90 |
| H4 | 3.3 | 56.1 | 85 |

It has turned out from Table 6 that discharge capacity is high when the cathode mix in the positive electrode plate has a packing density of 2.6 g·cm⁻³ or more and that charge/discharge efficiency can be kept high when the packing density is 3.1 g·cm⁻³ or less.

According to the present invention, a reduction in charge transfer resistance or diffusion resistance in the electrodes can be realized, thereby further improving the charge/discharge characteristics.

What is claimed is:

1. A nonaqueous electrolyte secondary battery comprising: a positive electrode composed of a metal oxide; a negative electrode composed of carbon material capable of electrochemically absorbing and desorbing lithium; and a nonaqueous electrolyte, wherein said positive active material is LiCo₁₋ₐTiₐO₂ (0.003≦a≦0.015).

2. The nonaqueous electrolyte secondary battery according to claim 1, wherein said positive active material is LiCo₁₋ₐTiₐO₂ (0.006≦a≦0.012).

3. The nonaqueous electrolyte secondary battery according to claim 1, wherein the particles of said positive active material is 2 to 30 μm in mean diameter.

4. The nonaqueous electrolyte secondary battery according to claim 1, wherein the particles of said positive active material is 5 to 15 μm in mean diameter.

5. The nonaqueous electrolyte secondary battery according to claim 1, wherein said nonaqueous electrolyte contains dimethyl carbonate.

6. The nonaqueous electrolyte secondary battery according to claim 5, wherein volume content of dimethyl carbonate in said nonaqueous electrolyte is in the range of 10 to 90%.

7. The nonaqueous electrolyte secondary battery according to claim 5, wherein volume content of dimethyl carbonate in said nonaqueous electrolyte is in the range of 30 to 70%.

8. The nonaqueous electrolyte secondary battery according to claim 5, wherein said nonaqueous electrolyte contains dimethyl carbonate and ethyl methyl carbonate.

9. The nonaqueous electrolyte secondary battery according to claim 1, wherein said positive electrode has 0.1 to 1.2 mm thick.

10. The nonaqueous electrolyte secondary battery according to claim 1, wherein said positive electrode has 0.3 to 0.8 mm thick.

11. The nonaqueous electrolyte secondary battery according to claim 1, wherein said nonaqueous electrolyte secondary battery is coin type.

12. A coin-type nonaqueous electrolyte secondary battery comprising:
a positive electrode plate composed of a cathode mix containing positive active material composed of a metal oxide, an electronic conductor, and a binder;
a negative electrode plate composed of carbon material capable of electrochemically absorbing and desorbing lithium;
a separator interposed between said positive electrode plate and said negative electrode plate; and
a nonaqueous electrolyte,
wherein said positive electrode plate has 0.1 to 1.2 mm thick, and said cathode mix contains 8.2 to 14.0% by weight of said electronic conductor.

13. The coin-type nonaqueous electrolyte secondary battery according to claim 12, wherein 9.0 to 11.5% by weight of said electronic conductor is contained.

14. The coin-type nonaqueous electrolyte secondary battery according to claim 12, wherein said positive active material has a mean particle diameter of 2 to 20 μm.

15. The coin-type nonaqueous electrolyte secondary battery according to claim 12, wherein said cathode mix has a packing density of 2.6 to 3.1 g·cm⁻³.
